(19) United States
(12) Patent Application Publication
(10) Pub. No.: US 2016/0099729 A1
(43) Pub. Date: Apr. 7, 2016

(54) APPARATUS AND METHOD FOR QUADRUPLING FREQUENCY OF REFERENCE CLOCK

(71) Applicant: QUALCOMM Incorporated, San Diego, CA (US)

(72) Inventors: Yashar RAJAVI, Mountain View, CA (US); Alireza KHALILI, Sunnyvale, CA (US); Amirpouya KAVOUSIAN, San Jose, CA (US); Mohammad Mahdi GHAHRAMANI, San Jose, CA (US); Mohammad Bagher VAHID FAR, San Jose, CA (US)

(21) Appl. No.: 14/605,734

(22) Filed: Jan. 26, 2015

Related U.S. Application Data
(60) Provisional application No. 62/059,041, filed on Oct. 2, 2014.

(51) Int. Cl. H04B 1/04; H04B 15/04; H04L 7/00

(52) U.S. Cl. CPC H04B 1/04; H04L 7/0012; H04B 15/04; H04B 2001/0408

(57) ABSTRACT

A method, an apparatus, and a computer program product are provided. The apparatus outputs a first sinusoidal signal and a second sinusoidal signal according to a first clock frequency, generates, a first digital signal having a 25% duty cycle based on the first sinusoidal signal, generates a second digital signal having a 25% duty cycle based on the second sinusoidal signal, combines the first digital signal and the second digital signal to generate a combined digital signal having a 50% duty cycle and a second clock frequency that is double the first clock frequency, and doubles the second clock frequency of the combined digital signal to generate an output signal having a third clock frequency that is quadruple the first clock frequency. The apparatus further generates a control voltage for the first buffer and the second buffer based on the combined digital signal.

### CROSS-REFERENCE TO RELATED APPLICATION(S)

This application claims the benefit of U.S. Provisional Application Ser. No. 62/059,041, entitled “APPARATUS AND METHOD FOR QUADRUPLING FREQUENCY OF REFERENCE CLOCK” and filed on Oct. 2, 2014, which is expressly incorporated by reference herein in its entirety.

### BACKGROUND

1. Field

The present disclosure relates generally to communication systems, and more particularly, to an apparatus and method for quadrupling a clock frequency.

2. Background

A wireless device (e.g., a cellular phone or a smartphone) may transmit and receive data for two-way communication with a wireless communication system. The wireless device may include a transmitter for data transmission and a receiver for data reception. For data transmission, the transmitter may modulate a transmit local oscillator (LO) signal with data to obtain a modulated radio frequency (RF) signal, amplify the modulated RF signal to obtain an output RF signal having the desired output power level, and transmit the output RF signal via an antenna to a base station. For data reception, the receiver may obtain a received RF signal via the antenna, downconvert the received RF signal with a receive LO signal, and process the downconverted signal to recover data sent by the base station.

The wireless device may include one or more oscillators to generate one or more oscillator signals at one or more desired frequencies. The oscillator signal(s) may be used to generate the transmit LO signal for the transmitter and the receive LO signal for the receiver. The oscillator(s) may be required to generate the oscillator signal(s) to meet the requirements of the wireless communication system with which the wireless device communicates.

Clock generators may receive oscillator signals from an oscillator and may generate clock signals for various modules within the wireless device. A way to improve phase noise (PN) performance of particular device modules is to increase a frequency of a reference clock signal from a clock generator. However, previous attempts to increase the reference clock signal frequency have come at the cost of large power consumption, large device area use, and mediocre PN performance. Accordingly, an apparatus and method is needed for increasing the reference clock signal frequency to improve PN performance without suffering large power consumption or device area use.

### SUMMARY

In an aspect of the disclosure, a method and an apparatus are provided. The apparatus outputs, via a voltage-controlled oscillator (VCO), a first sinusoidal signal and a second sinusoidal signal according to a first clock frequency, wherein the first sinusoidal signal is out of phase with the second sinusoidal signal by half a cycle, generates, via a first buffer, a first digital signal having a 25% duty cycle based on the first sinusoidal signal, generates, via a second buffer, a second digital signal having a 25% duty cycle based on the second sinusoidal signal, combines, via a combining module, the first digital signal and the second digital signal to generate a combined digital signal having a 50% duty cycle, the combined digital signal having a second clock frequency that is double the first clock frequency, and doubles, via a frequency doubling module, the second clock frequency of the combined digital signal to generate an output signal having a third clock frequency that is quadruple the first clock frequency. Furthermore, the apparatus generates, via a duty cycle correction (DCC) module, a control voltage for the first buffer and the second buffer based on the combined digital signal, wherein the control voltage controls a voltage threshold of the first buffer facilitating the first buffer to generate the first digital signal having the 25% duty cycle and a voltage threshold of the second buffer facilitating the second buffer to generate the second digital signal having the 25% duty cycle.

### BRIEF DESCRIPTION OF THE DRAWINGS

FIG. 1 illustrates a wireless device communicating with different wireless communication systems.

FIG. 2 is a block diagram of a wireless device.

FIG. 3 is a block diagram illustrating a reference clock quadrupler.

FIG. 4 is an example schematic circuit diagram illustrating the reference clock quadrupler of FIG. 3.

FIG. 5 illustrates diagrams of alternative examples of implementing a first buffer and a second buffer.

FIG. 6 is a flow chart of a method of quadrupling a clock frequency.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. The term “exemplary” is used herein to mean “serving as an example, instance, or illustration.” Any design described herein as “exemplary” is not necessarily to be construed as preferred or advantageous over other designs.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise random-access memory (RAM), read-only memory (ROM), electronically erasable programmable ROM (EEPROM), compact disk (CD) ROM (CD-ROM), or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

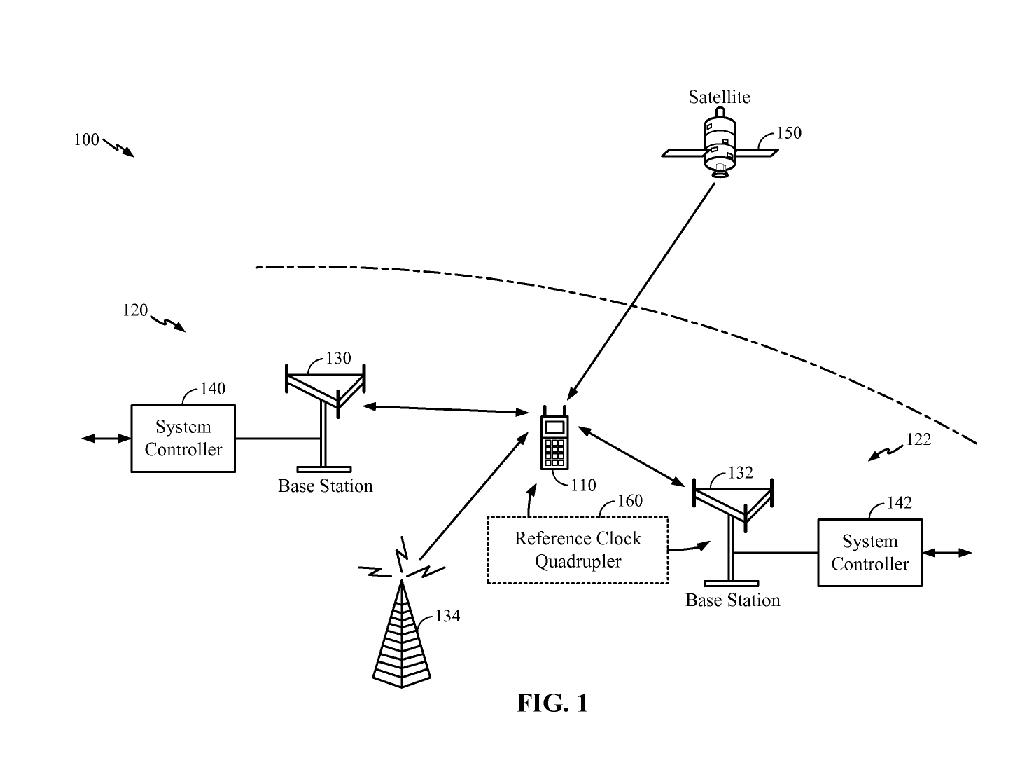

FIG. 1 is a diagram 100 illustrating a wireless device 110 communicating with different wireless communication systems 120, 122. The wireless systems 120, 122 may each be a Code Division Multiple Access (CDMA) system, a Global System for Mobile Communications (GSM) system, a Long Term Evolution (LTE) system, a wireless local area network (WLAN) system, or some other wireless system. A CDMA system may implement Wideband CDMA (WCDMA), CDMA 1× or cdma2000, Time Division Synchronous Code Division Multiple Access (TD-SCDMA), or some other version of CDMA. TD-SCDMA is also referred to as Universal Terrestrial Radio Access (UTRA) Time Division Duplex (TDD) 1.28 Mcps Option or Low Chip Rate (LCR). LTE supports both frequency division duplexing (FDD) and time division duplexing (TDD). For example, the wireless system 120 may be a GSM system, and the wireless system 122 may be a WCDMA system. As another example, the wireless system 120 may be an LTE system, and the wireless system 122 may be a CDMA system.

For simplicity, the diagram 100 shows the wireless system 120 including one base station 130 and one system controller 140, and the wireless system 122 including one base station 132 and one system controller 142. In general, each wireless system may include any number of base stations and any set of network entities. Each base station may support communication for wireless devices within the coverage of the base station. The base stations may also be referred to as a Node B, an evolved Node B (eNB), an access point, a base transceiver station, a radio base station, a radio transceiver, a transceiver function, a basic service set (BSS), an extended service set (ESS), or some other suitable terminology. The wireless device 110 may also be referred to as a user equipment (UE), a mobile device, a remote device, a wireless device, a wireless communications device, a station, a mobile station, a subscriber station, a mobile subscriber station, a terminal, a mobile terminal, a remote terminal, a wireless terminal, an access terminal, a client, a mobile client, a mobile unit, a subscriber unit, a wireless unit, a remote unit, a handset, a user agent, or some other suitable terminology. The wireless device 110 may be a cellular phone, a smartphone, a tablet, a wireless modem, a personal digital assistant (PDA), a handheld device, a laptop computer, a smartbook, a netbook, a cordless phone, a wireless local loop (WLL) station, or some other similar functioning device.

The wireless device 110 may be capable of communicating with the wireless system 120 and/or 122. The wireless device 110 may also be capable of receiving signals from broadcast stations, such as the broadcast station 134. The wireless device 110 may also be capable of receiving signals from satellites, such as the satellite 150, in one or more global navigation satellite systems (GNSS). The wireless device 110 may support one or more radio technologies for wireless communication such as GSM, WCDMA, cdma2000, LTE, 802.11, etc. The terms “radio technology,” “radio access technology,” “air interface,” and “standard” may be used interchangeably.

The wireless device 110 may communicate with a base station in a wireless system via the downlink and the uplink. The downlink (or forward link) refers to the communication link from the base station to the wireless device, and the uplink (or reverse link) refers to the communication link from the wireless device to the base station. A wireless system may utilize TDD and/or FDD. For TDD, the downlink and the uplink share the same frequency, and downlink transmissions and uplink transmissions may be sent on the same frequency in different time periods.

For FDD, the downlink and the uplink are allocated separate frequencies. Downlink transmissions may be sent on one frequency, and uplink transmissions may be sent on another frequency. Some exemplary radio technologies supporting TDD include GSM, LTE, and TD-SCDMA. Some exemplary radio technologies supporting FDD include WCDMA, cdma2000, and LTE. The wireless device 110 and/or the base stations 130, 132 may include an exemplary reference clock quadrupler 160. An exemplary reference clock quadrupler 160 is provided infra.

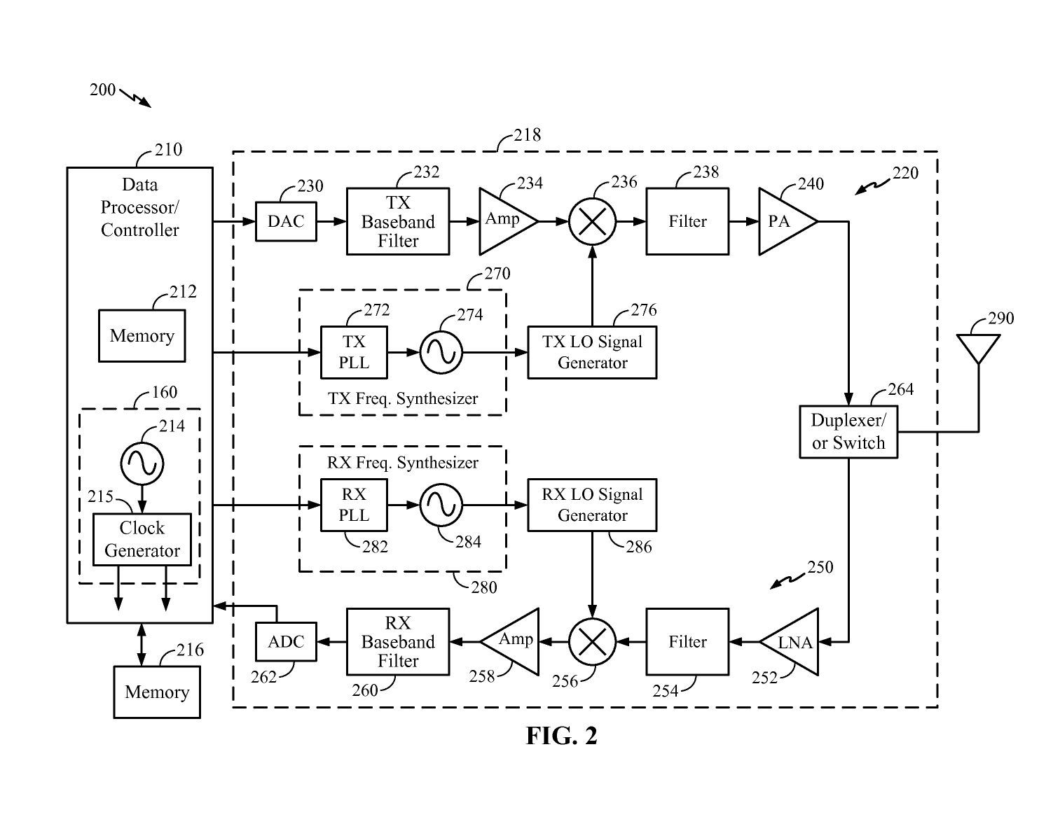

FIG. 2 is a block diagram 200 of an exemplary wireless device, such as the wireless device 110. The wireless device includes a data processor/controller 210, a transceiver 218, and an antenna 290. The data processor/controller 210 may be referred to as a processing system. A processing system may include the data processor/controller 210 or both the data processor/controller 210 and the memory 216. The transceiver 218 includes a transmitter 220 and a receiver 250 that support bi-directional communication. The transmitter 220 and/or the receiver 250 may be implemented with a super-heterodyne architecture or a direct-conversion architecture. In the super-heterodyne architecture, a signal is frequency converted between RF and baseband in multiple stages, e.g., from RF to an intermediate frequency (IF) in one stage, and then from IF to baseband in another stage for a receiver. In the direct-conversion architecture, which is also referred to as a zero-IF architecture, a signal is frequency converted between RF and baseband in one stage. The super-heterodyne and direct-conversion architectures may use different circuit blocks and/or have different requirements. In the exemplary design shown in FIG. 2, the transmitter 220 and the receiver 250 are implemented with the direct-conversion architecture.

In the transmit path, the data processor/controller 210 may process (e.g., encode and modulate) data to be transmitted and provide the data to a digital-to-analog converter (DAC) 230. The DAC 230 converts a digital input signal to an analog output signal. The analog output signal is provided to a transmit (TX) baseband (lowpass) filter 232, which may filter the analog output signal to remove images caused by the prior digital-to-analog conversion by the DAC 230. An amplifier (amp) 234 may amplify the signal from the TX baseband filter 232 and provide an amplified baseband signal. An upconverter (mixer) 236 may receive the amplified baseband signal and a TX LO signal from a TX LO signal generator 276. The upconverter 236 may upconvert the amplified baseband signal with the TX LO signal and provide an upconverted signal. A filter 238 may filter the upconverted signal to remove images caused by the frequency upconversion. A power amplifier (PA) 240 may amplify the filtered RF signal from the filter 238 to obtain the desired output power level and provide an output RF signal. The output RF signal may be routed through a duplexer/switchplexer 264.

For FDD, the transmitter 220 and the receiver 250 may be coupled to the duplexer 264, which may include a TX filter for the transmitter 220 and a receive (RX) filter for the receiver 250. The TX filter may filter the output RF signal to pass signal components in a transmit band and attenuate signal components in a receive band. For TDD, the transmitter 220 and the receiver 250 may be coupled to switchplexer 264. The switchplexer 264 may pass the output RF signal from the transmitter 220 to the antenna 290 during uplink time intervals. For both FDD and TDD, the duplexer/switchplexer 264 may provide the output RF signal to the antenna 290 for transmission via a wireless channel.

In the receive path, the antenna 290 may receive signals transmitted by base stations and/or other transmitter stations and may provide a received RF signal. The received RF signal may be routed through duplexer/switchplexer 264. For FDD, the RX filter within the duplexer 264 may filter the received RF signal to pass signal components in a receive band and attenuate signal components in the transmit band. For TDD, the switchplexer 264 may pass the received RF signal from the antenna 290 to the receiver 250 during downlink time intervals. For both FDD and TDD, the duplexer/switchplexer 264 may provide the received RF signal to the receiver 250.

Within the receiver 250, the received RF signal may be amplified by a low noise amplifier (LNA) 252 and filtered by a filter 254 to obtain an input RF signal. A downconverter (mixer) 256 may receive the input RF signal and an RX LO signal from an RX LO signal generator 286. The downconverter 256 may downconvert the input RF signal with the RX LO signal and provide a downconverted signal. The downconverted signal may be amplified by an amplifier 258 and further filtered by an RX baseband (lowpass) filter 260 to obtain an analog input signal. The analog input signal is provided to an analog-to-digital converter (ADC) 262. The ADC 262 converts an analog input signal to a digital output signal. The digital output signal is provided to the data processor/controller 210.

A TX frequency synthesizer 270 may include a TX phase locked loop (PLL) 272 and a VCO 274. The VCO 274 may generate a TX VCO signal at a desired frequency. The TX PLL 272 may receive timing information from the data processor/controller 210 and generate a control signal for the VCO 274. The control signal may adjust the frequency and/or the phase of the VCO 274 to obtain the desired frequency for the TX VCO signal. The TX frequency synthesizer 270 provides the TX VCO signal to the TX LO signal generator 276. The TX LO signal generator 276 may generate a TX LO signal based on the TX VCO signal received from the TX frequency synthesizer 270.

A RX frequency synthesizer 280 may include an RX PLL 282 and a VCO 284. The VCO 284 may generate an RX VCO signal at a desired frequency. The RX PLL 282 may receive timing information from the data processor/controller 210 and generate a control signal for the VCO 284. The control signal may adjust the frequency and/or the phase of the VCO 284 to obtain the desired frequency for the RX VCO signal. The RX frequency synthesizer 280 provides the RX VCO signal to the RX LO signal generator 286. The RX LO signal generator may generate an RX LO signal based on the RX VCO signal received from the RX frequency synthesizer 280.

The LO signal generators 276, 286 may each include frequency dividers, buffers, etc. The LO signal generators 276, 286 may be referred to as frequency dividers if they divide a frequency provided by the TX frequency synthesizer 270 and the RX frequency synthesizer 280, respectively. The PLLs 272, 282 may each include a phase/frequency detector, a loop filter, a charge pump, a frequency divider, etc. Each VCO signal and each LO signal may be a periodic signal with a particular fundamental frequency. The TX LO signal and the RX LO signal from the LO generators 276, 286 may have the same frequency for TDD or different frequencies for FDD. The TX VCO signal and the RX VCO signal from the VCOs 274, 284 may have the same frequency (e.g., for TDD) or different frequencies (e.g., for FDD or TDD).

The conditioning of the signals in the transmitter 220 and the receiver 250 may be performed by one or more stages of amplifier, filter, upconverter, downconverter, etc. These circuits may be arranged differently from the configuration shown in FIG. 2. Furthermore, other circuits not shown in FIG. 2 may also be used to condition the signals in the transmitter 220 and the receiver 250. For example, impedance matching circuits may be located at the output of the PA 240, at the input of the LNA 252, between the antenna 290 and the duplexer/switchplexer 264, etc. Some circuits in FIG. 2 may also be omitted. For example, the filter 238 and/or the filter 254 may be omitted. All or a portion of the transceiver 218 may be implemented on one or more analog integrated circuits (ICs), RF ICs (RFICs), mixed-signal ICs, etc. For example, the TX baseband filter 232 to the PA 240 in the transmitter 220, the LNA 252 to the RX baseband filter 260 in the receiver 250, the PLLs 272, 282, the VCOs 274, 284, and the LO signal generators 276, 286 may be implemented on an RFIC. The PA 240 and possibly other circuits may also be implemented on a separate IC or a circuit module.

The data processor/controller 210 may perform various functions for the wireless device. For example, the data processor/controller 210 may perform processing for data being transmitted via the transmitter 220 and received via the receiver 250. The data processor/controller 210 may control the operation of various circuits within the transmitter 220 and the receiver 250. The memory 212 and/or the memory 216 may store program codes and data for the data processor/controller 210. The memory may be internal to the data processor/controller 210 (e.g., the memory 212) or external to the data processor/controller 210 (e.g., the memory 216). The memory may be referred to as a computer-readable medium. An oscillator 214 may generate a VCO signal at a particular frequency. In an aspect, the oscillator 214 may be a differential VCO outputting two sinusoidal signals that are out of phase (e.g., by half a cycle) with respect to each other. A clock generator 215 may receive the VCO signal(s) from the oscillator 214 and may generate clock signals for various modules within the data processor/controller 210 and/or the transceiver 218. In an aspect, the oscillator 214 and the clock generator 215 are part of an exemplary reference clock quadrupler 160. The data processor/controller 210 may be implemented on one or more application specific integrated circuits (ASICs) and/or other ICs.

In an aspect, methods for improving phase noise (PN) performance of fractional-N RF synthesizers or any PLL (e.g., TX frequency synthesizer 270 or RX frequency synthesizer 280) involve increasing a reference clock signal frequency. For example, a reference clock frequency of a delay locked loop (DLL) or an integer-N PLL may be multiplied. However, doing so may suffer from large power consumption, large device area use, and/or mediocre PN performance. Accordingly, the present disclosure provides for an apparatus and method that quadruples a clock frequency of a signal from a sinusoidal signal source (e.g., crystal oscillator, differential VCO, etc.) while consuming less power, utilizing less device area, and improving PN performance.

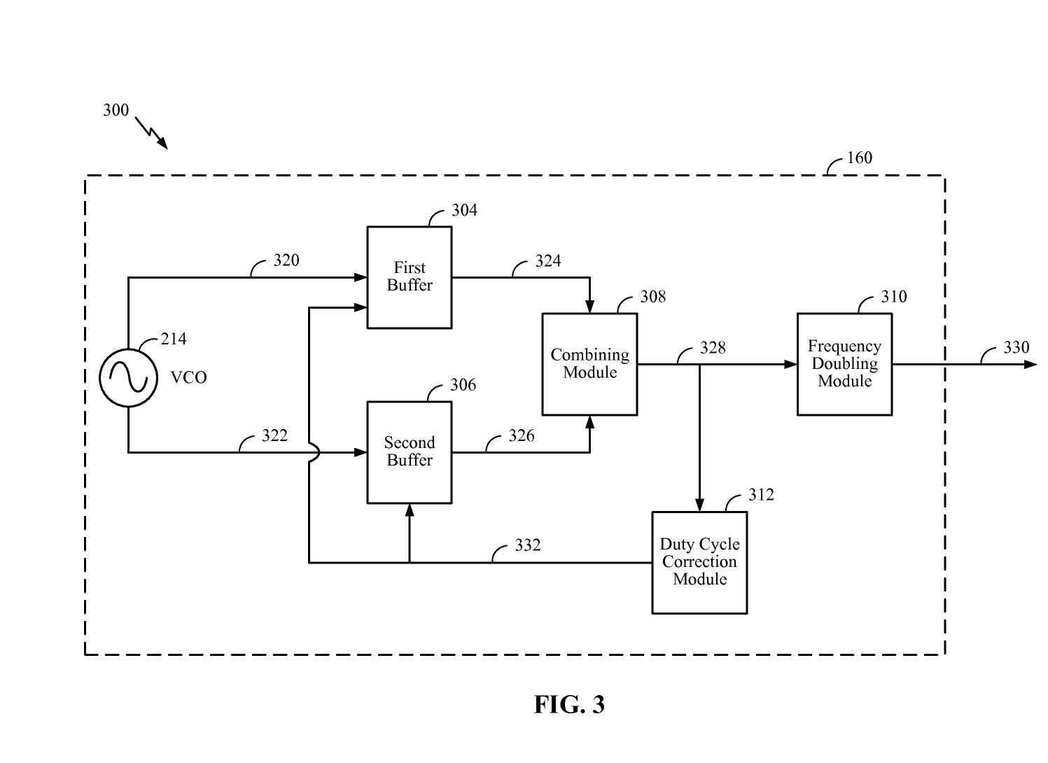

FIG. 3 is a block diagram 300 illustrating a reference clock quadrupler 160. The reference clock quadrupler 160 may include a first buffer 304, a second buffer 306, a combining module 308, a frequency doubling module 310, and a duty cycle correction module (DCC) 312. The reference clock quadrupler 160 may further include an oscillator, such as a voltage-controlled oscillator 214.

Referring to FIG. 3, an oscillator (e.g., differential voltage-controlled oscillator (VCO)) 214 outputs a first sinusoidal signal 320 to the first buffer 304 and a second sinusoidal signal 322 to the second buffer 306. The first sinusoidal signal 320 and the second sinusoidal signal 322 may be outputted according to a first clock frequency (e.g., reference clock frequency). Moreover, the first sinusoidal signal 320 may be out of phase with the second sinusoidal signal 322 by half a cycle (e.g., 180 degrees).

The first buffer 304 receives the first sinusoidal signal 320 and generates a first digital signal having a 25% duty cycle based on the first sinusoidal signal 320. The first buffer 304 then outputs the first digital signal 324 having the 25% duty cycle to the combining module 308. The second buffer 306 receives the second sinusoidal signal 322 and generates a second digital signal having a 25% duty cycle based on the second sinusoidal signal 322. The second buffer 306 then outputs the second digital signal 326 having the 25% duty cycle to the combining module 308. In an aspect, the first buffer 304 and the second buffer 306 are inverters whose voltage thresholds are skewed in order to generate the digital signals having the 25% duty cycle.

The combining module 308 receives the first digital signal 324 and the second digital signal 326 and combines the signals to generate a combined digital signal having a 50% duty cycle and a second clock frequency that is twice the first clock frequency (2× clock). The combining module 308 then outputs the combined digital signal 328 to the frequency doubling module 310 and/or the DCC) module 312. In an aspect, the combining module 308 generates the combined digital signal to have four clean edges during one cycle with minimal phase noise degradation. The four clean edges may then be inputted to the frequency doubling module 310.

The frequency doubling module 310 receives the combined digital signal 328 (e.g., four clean edges) and doubles the second clock frequency of the combined digital signal 328 to generate an output signal having a third clock frequency that is quadruple the first clock frequency (4× clock). The frequency doubling module 310 may then output the output signal 330 to various modules of the transceiver 218, such as the TX frequency synthesizer 270 (via the TX PLL 272) and/or the RX frequency synthesizer 280 (via the RX PLL 282).

The DCC module 312 receives the combined digital signal 328 and generates a control voltage for driving the first buffer 304 and the second buffer 306 based on the combined digital signal 328. The DCC module 312 outputs the control voltage 332 to the first buffer 304 and the second buffer 306. In an aspect, the control voltage 332 controls/skews a voltage threshold of the first buffer 304 facilitating the first buffer 304 to generate the first digital signal 324 having the 25% duty cycle. Similarly, the control voltage 332 controls/skews a voltage threshold of the second buffer 306 facilitating the second buffer 306 to generate the second digital signal 326 having the 25% duty cycle.

The feedback provided by the DCC module 312 to the first buffer 304 and the second buffer 306 ensures the ability of the combining module 308 to output a 50% duty cycle signal 328. That is, the feedback ensures the ability of the combining module 308 to generate a digital signal with four clean edges during one cycle. Correspondingly, the 50% duty cycle signal 328 (digital signal with four clean edges) ensures the ability of the frequency doubling module 310 to output a spur-free output signal 330 having the 4× clock. The spur-free output signal 330 having the 4× clock improves PN performance when inputted to the TX frequency synthesizer 270 (via the TX PLL 272) and/or the RX frequency synthesizer 280 (via the RX PLL 282).

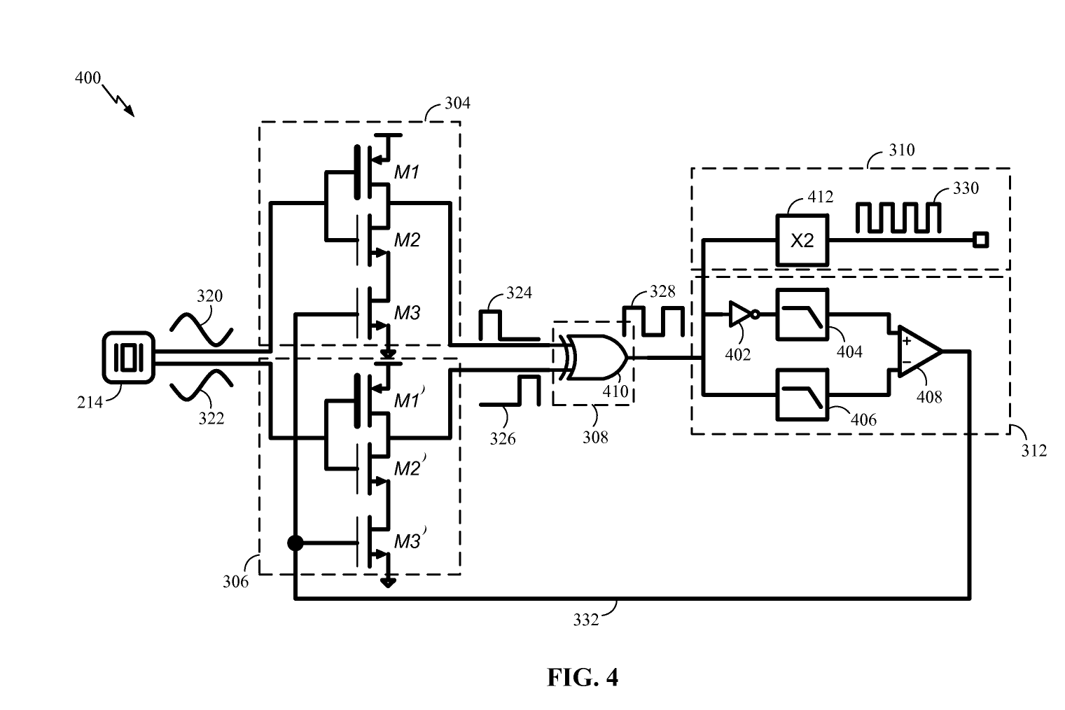

FIG. 4 is an example schematic circuit diagram 400 illustrating the reference clock quadrupler of FIG. 3. Referring to FIGS. 3 and 4, the first buffer 304 may include a first transistor M1, a second transistor M2, and a third transistor M3. A source of the first transistor M1 is coupled to a voltage source, a gate of the first transistor M1 is coupled to a first output of the oscillator 214 outputting the first sinusoidal signal 320, and a drain of the first transistor M1 is coupled to a first input of the combining module 308. A gate of the second transistor M2 is coupled to the first output of the oscillator 214 outputting the first sinusoidal signal 320, a drain of the second transistor M2 is coupled to the first input of the combining module 308, and a source of the second transistor M2 is coupled to a drain of the third transistor M3. A source of the third transistor M3 is coupled to a ground node, a gate of the third transistor M3 is coupled to an output of the DCC module 312 outputting the control voltage 332, and the drain of the third transistor M3 is coupled to the source of the second transistor M2. In an aspect, the first transistor M1 may be an I/O MOS, the second transistor M2 may be a native MOS, and the third transistor M3 may be a native MOS.

The second buffer 306 may include a fourth transistor M1′, a fifth transistor M2′, and a sixth transistor M3′. A source of the fourth transistor M1′ is coupled to a voltage source, a gate of the fourth transistor M1′ is coupled to a second output of the oscillator 214 outputting the second sinusoidal signal 322, and a drain of the fourth transistor M1′ is coupled to a second input of the combining module 308. A gate of the fifth transistor M2′ is coupled to the second output of the oscillator 214 outputting the second sinusoidal signal 322, a drain of the fifth transistor M2′ is coupled to the second input of the combining module 308, and a source of the fifth transistor M2′ is coupled to a drain of the sixth transistor M3′. A source of the sixth transistor M3′ is coupled to a ground node, a gate of the sixth transistor M3′ is coupled to the output of the DCC module 312 outputting the control voltage 332, and the drain of the sixth transistor M3′ is coupled to the source of the fifth transistor M2′. In an aspect, the fourth transistor M1′ may be an I/O MOS, the fifth transistor M2′ may be a native MOS, and the sixth transistor M3′ may be a native MOS.

The combining module 308 may include an exclusive-or (XOR) gate 410. The exclusive-or gate 410 receives the first digital signal 324 from the first buffer 304 as a first input and receives the second digital signal 326 from the second buffer 306 as a second input. The exclusive-or gate 410 performs an exclusive-or operation using the first digital signal 324 and the second digital signal 326 and outputs a result of the exclusive-or operation as the combined digital signal 328. Although an XOR gate is described with respect to FIG. 4, the present disclosure is not limited thereto. For example, an OR gate may be implemented in place of the XOR gate.

The frequency doubling module 310 may include a doubler 412. The doubler 412 doubles the clock frequency of the combined digital signal 328 to generate the output signal 330. For example, after the doubler 412 receives the combined digital signal 328 from the combining module 308, the doubler 412 performs an exclusive-or operation (e.g., via an XOR gate) using the combined digital signal 328 as a first input and a delayed version of the combined digital signal as a second input, and outputs a result of the exclusive-or operation as the output signal 330.

The DCC module 312 may include an inverter 402, a first low pass filter (LPF) 404, a second LPF 406, and an operational amplifier 408. The inverter 402 inverts the combined digital signal 328 to generate an inverse combined digital signal. The first LPF 404 generates an average of the inverse combined digital signal. The second LPF 406 generates an average of the combined digital signal 328. The operational amplifier 408 receives the average of the inverse combined digital signal via a non-inverting input and the average of the combined digital signal via an inverting input. The operational amplifier 408 further determines a difference in voltage between the average of the inverse combined digital signal and the average of the combined digital signal, and amplifies the voltage difference to generate the control voltage 332. Although the DCC module 312 providing DCC feedback to the first buffer 304 and the second buffer 306 is described to include the specific elements mentioned above, a DCC feedback loop of the present disclosure is not limited thereto as any type of DCC feedback system capable of sensing a clock duty cycle may be used in accordance with the present disclosure.

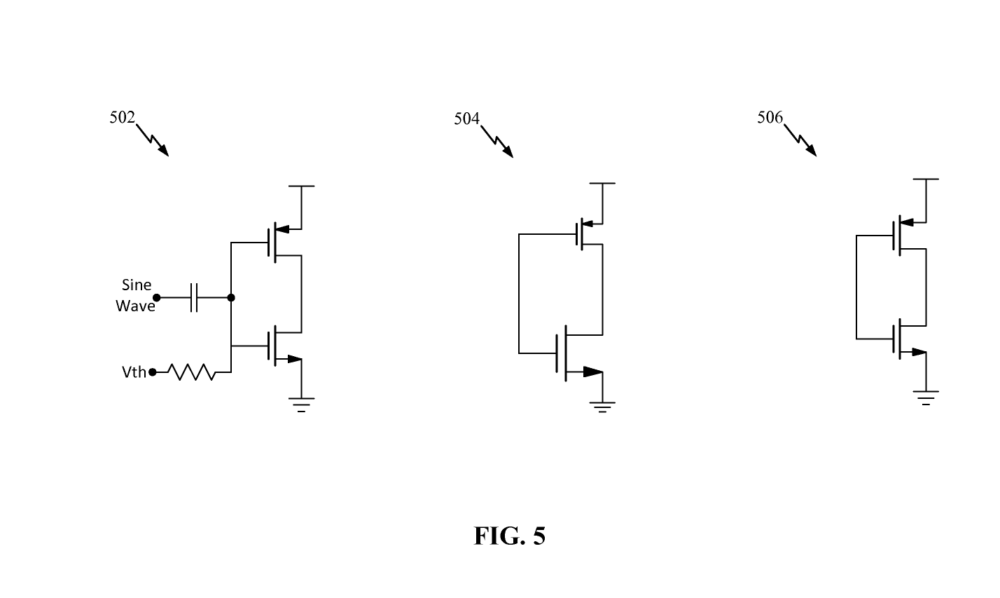

FIG. 5 illustrates diagrams of alternative examples of implementing the first buffer 304 and the second buffer 306. As shown in 502, the first buffer 304 and/or the second buffer 306 may be implemented using AC coupling and shifting a transition point. As shown in 504, the first buffer 304 and/or the second buffer 306 may be implemented by sizing PMOS and NMOS differently. As shown in 506, the first buffer 304 and/or the second buffer 306 may be implemented using PMOS and NMOS with different threshold voltages.

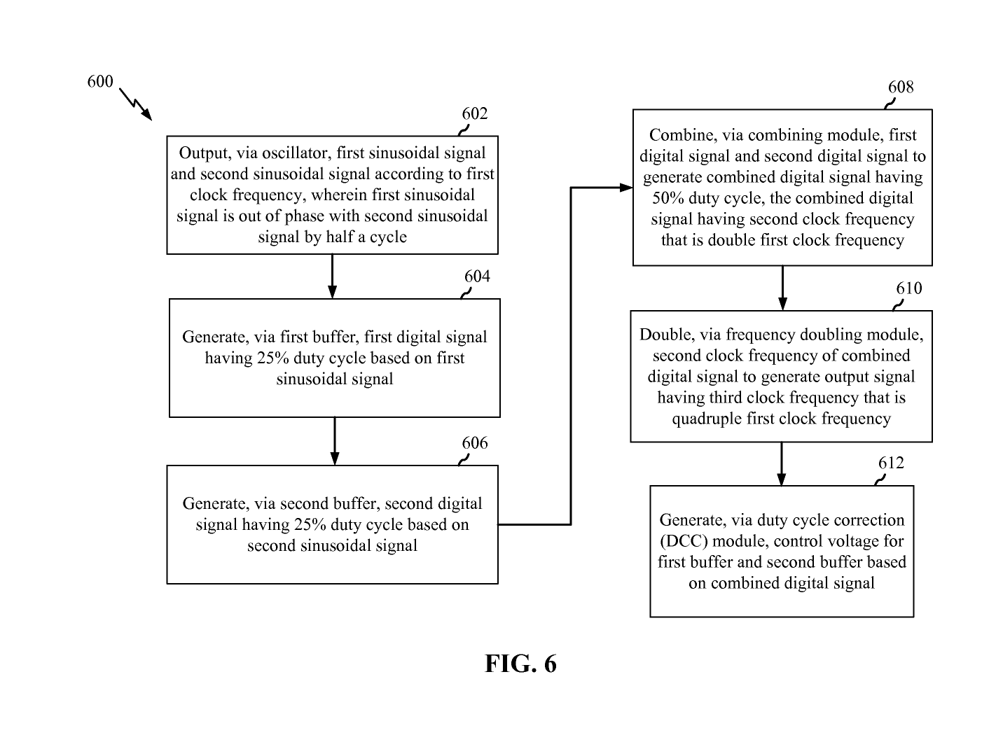

FIG. 6 is a flow chart 600 of a method of quadrupling a clock frequency. The method may be performed by an apparatus (e.g., reference clock quadrupler 160), via one or more of the oscillator 214, the first buffer 304, the second buffer 306, the combining module 308, the frequency doubling module 310, or the duty cycle correction (DCC) module 312.

At block 602, the apparatus outputs, via the oscillator 214, a first sinusoidal signal and a second sinusoidal signal according to a first clock frequency (reference clock frequency). The first sinusoidal signal is out of phase with the second sinusoidal signal by half a cycle. In an aspect, the oscillator 214 is a differential voltage-controlled oscillator (VCO).

At block 604, the apparatus generates, via the first buffer 304, a first digital signal having a 25% duty cycle based on the first sinusoidal signal. In an aspect, the first buffer 304 includes a first transistor, a second transistor, and a third transistor. A gate of the first transistor is coupled to a first output of the oscillator 214 outputting the first sinusoidal signal, and a drain of the first transistor is coupled to a first input of the combining module 308. A gate of the second transistor is coupled to the first output of the oscillator 214 outputting the first sinusoidal signal, a drain of the second transistor is coupled to the first input of the combining module 308, and a source of the second transistor is coupled to a drain of the third transistor. A gate of the third transistor is coupled to an output of the DCC module 312 outputting a control voltage, and the drain of the third transistor is coupled to the source of the second transistor. A source of the first transistor is coupled to a voltage source and a source of the third transistor is coupled to a ground node.

At block 606, the apparatus generates, via the second buffer 306, a second digital signal having a 25% duty cycle based on the second sinusoidal signal. In an aspect, the second buffer 306 includes a fourth transistor, a fifth transistor, and a sixth transistor, A gate of the fourth transistor is coupled to a second output of the oscillator 214 outputting the second sinusoidal signal, and a drain of the fourth transistor is coupled to a second input of the combining module 308. A gate of the fifth transistor is coupled to the second output of the oscillator 214 outputting the second sinusoidal signal, a drain of the fifth transistor is coupled to the second input of the combining module 308, and a source of the fifth transistor is coupled to a drain of the sixth transistor. A gate of the sixth transistor is coupled to the output of the DCC module 312 outputting a control voltage, and the drain of the sixth transistor is coupled to the source of the fifth transistor. A source of the fourth transistor is coupled to a voltage source and a source of the sixth transistor is coupled to a ground node.

At block 608, the apparatus combines, via the combining module 308, the first digital signal and the second digital signal to generate a combined digital signal having a 50% duty cycle. The combined digital signal may have a second clock frequency that is double the first clock frequency. In an aspect, the combining module 308 generates the combined digital signal by receiving the first digital signal from the first buffer 304 as a first input, receiving the second digital signal from the second buffer 306 as a second input, performing an exclusive-or operation using the first input and the second input, and outputting a result of the exclusive-or operation as the combined digital signal.

At block 610, the apparatus doubles, via the frequency doubling module 310, the second clock frequency of the combined digital signal to generate an output signal having a third clock frequency that is quadruple the first clock frequency. In an aspect, the frequency doubling module 310 generates the output signal by receiving the combined digital signal from the combining module 308, performing an exclusive-or operation using the combined digital signal as a first input and a delayed version of the combined digital signal as a second input, and outputting a result of the exclusive-or operation as the output signal.

At block 612, the apparatus generates, via the DCC module 312, a control voltage for the first buffer 304 and the second buffer 306 based on the combined digital signal. In an aspect, the control voltage controls a voltage threshold of the first buffer 304 facilitating the first buffer 304 to generate the first digital signal having the 25% duty cycle, and controls a voltage threshold of the second buffer 306 facilitating the second buffer 306 to generate the second digital signal having the 25% duty cycle.

In an aspect, the DCC module 312 generates the control voltage by inverting, via an inverter 402, the combined digital signal to generate an inverse combined digital signal, generating, via a first LPF 404, an average of the inverse combined digital signal, and generating, via a second LPF 406, an average of the combined digital signal. Thereafter, the DCC module 312 receives, via a non-inverting input of an amplifier 408, the average of the inverse combined digital signal, receives, via an inverting input of the amplifier 408, the average of the combined digital signal, determines, via the amplifier 408, a difference in voltage between the average of the inverse combined digital signal and the average of the combined digital signal, and amplifies, via the amplifier 408, the voltage difference to generate the control voltage.

Referring again to FIG. 3, an apparatus (e.g., reference clock quadrupler 160) may include the oscillator 214, the first buffer 304, the second buffer 306, the combining module 308, the frequency doubling module 310, or the duty cycle correction (DCC) module 312. The apparatus includes means for outputting a first sinusoidal signal and a second sinusoidal signal according to a first clock frequency, wherein the first sinusoidal signal is out of phase with the second sinusoidal signal by half a cycle. The apparatus further includes means for generating a first digital signal having a 25% duty cycle based on the first sinusoidal signal and means for generating a second digital signal having a 25% duty cycle based on the second sinusoidal signal. The apparatus also includes means for combining the first digital signal and the second digital signal to generate a combined digital signal having a 50% duty cycle, the combined digital signal having a second clock frequency that is double the first clock frequency. The apparatus includes means for doubling the second clock frequency of the combined digital signal to generate an output signal having a third clock frequency that is quadruple the first clock frequency. The apparatus further includes means for generating, based on the combined digital signal, a control voltage for the means for generating the first digital signal and the means for generating the second digital signal. The aforementioned means may be one or more of the oscillator 214, the first buffer 304, the second buffer 306, the combining module 308, the frequency doubling module 310, the duty cycle correction (DCC) module 312, the data processor/controller 210, the computer-readable medium, i.e., the memory 212, and/or the computer-readable medium, i.e., the memory 216 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. An apparatus for quadrupling a clock frequency, comprising:
a differential voltage-controlled oscillator (VCO) configured to output a first sinusoidal signal and a second sinusoidal signal according to a first clock frequency, wherein the first sinusoidal signal is out of phase with the second sinusoidal signal by half a cycle;
a first buffer configured to generate, based on the first sinusoidal signal, a first digital signal having a 25% duty cycle;
a second buffer configured to generate, based on the second sinusoidal signal, a second digital signal having a 25% duty cycle;
a combining module configured to combine the first digital signal and the second digital signal to generate a combined digital signal having a 50% duty cycle, the combined digital signal having a second clock frequency that is double the first clock frequency; and
a frequency doubling module configured to double the second clock frequency of the combined digital signal to generate an output signal having a third clock frequency that is quadruple the first clock frequency.

2. The apparatus of claim 1, further comprising:
a duty cycle correction (DCC) module configured to generate a control voltage for the first buffer and the second buffer based on the combined digital signal,
wherein the control voltage controls a threshold of the first buffer facilitating the first buffer to generate the first digital signal having the 25% duty cycle, and
wherein the control voltage controls a threshold of the second buffer facilitating the second buffer to generate the second digital signal having the 25% duty cycle.

3. The apparatus of claim 2, wherein the DCC module comprises:
an inverter configured to invert the combined digital signal to generate an inverse combined digital signal;
a first low pass filter configured to generate an average of the inverse combined digital signal;
a second low pass filter configured to generate an average of the combined digital signal; and
an amplifier configured to:
receive the average of the inverse combined digital signal via a non-inverting input,
receive the average of the combined digital signal via an inverting input,
determining a difference in voltage between the average of the inverse combined digital signal and the average of the combined digital signal, and
amplifying the voltage difference to generate the control voltage.

4. The apparatus of claim 2,
wherein the first buffer comprises a first transistor, a second transistor, and a third transistor,
wherein a gate of the first transistor is coupled to a first output of the differential VCO outputting the first sinusoidal signal, and a drain of the first transistor is coupled to a first input of the combining module,
wherein a gate of the second transistor is coupled to the first output of the differential VCO outputting the first sinusoidal signal, a drain of the second transistor is coupled to the first input of the combining module, and a source of the second transistor is coupled to a drain of the third transistor, and
wherein a gate of the third transistor is coupled to an output of the DCC module outputting the control voltage, and the drain of the third transistor is coupled to the source of the second transistor.

5. The apparatus of claim 4,
wherein the second buffer comprises a fourth transistor, a fifth transistor, and a sixth transistor,
wherein a gate of the fourth transistor is coupled to a second output of the differential VCO outputting the second sinusoidal signal, and a drain of the fourth transistor is coupled to a second input of the combining module,
wherein a gate of the fifth transistor is coupled to the second output of the differential VCO outputting the second sinusoidal signal, a drain of the fifth transistor is coupled to the second input of the combining module, and a source of the fifth transistor is coupled to a drain of the sixth transistor, and
wherein a gate of the sixth transistor is coupled to the output of the DCC module outputting the control voltage, and the drain of the sixth transistor is coupled to the source of the fifth transistor.

6. The apparatus of claim 5,
wherein a source of the first transistor and a source of the fourth transistor are coupled to a voltage source, and
wherein a source of the third transistor and a source of the sixth transistor are coupled to a ground node.

7. The apparatus of claim 1, wherein the combining module is configured to combine the first digital signal and the second digital signal to generate the combined digital signal by:
receiving the first digital signal from the first buffer as a first input;
receiving the second digital signal from the second buffer as a second input;
performing an exclusive-or operation using the first input and the second input; and
outputting a result of the exclusive-or operation as the combined digital signal.

8. The apparatus of claim 1, wherein the frequency doubling module is configured to double the second clock frequency of the combined digital signal to generate the output signal by:
receiving the combined digital signal from the combining module;
performing an exclusive-or operation using the combined digital signal as a first input and a delayed version of the combined digital signal as a second input; and
outputting a result of the exclusive-or operation as the output signal.

9. A method of quadrupling a clock frequency, comprising:
outputting, via a differential voltage-controlled oscillator (VCO), a first sinusoidal signal and a second sinusoidal signal according to a first clock frequency, wherein the first sinusoidal signal is out of phase with the second sinusoidal signal by half a cycle;
generating, via a first buffer, a first digital signal having a 25% duty cycle based on the first sinusoidal signal;
generating, via a second buffer, a second digital signal having a 25% duty cycle based on the second sinusoidal signal;
combining, via a combining module, the first digital signal and the second digital signal to generate a combined digital signal having a 50% duty cycle, the combined digital signal having a second clock frequency that is double the first clock frequency; and
doubling, via a frequency doubling module, the second clock frequency of the combined digital signal to generate an output signal having a third clock frequency that is quadruple the first clock frequency.

10. The method of claim 9, further comprising:
generating, via a duty cycle correction (DCC) module, a control voltage for the first buffer and the second buffer based on the combined digital signal,
wherein the control voltage controls a threshold of the first buffer facilitating the first buffer to generate the first digital signal having the 25% duty cycle, and
wherein the control voltage controls a threshold of the second buffer facilitating the second buffer to generate the second digital signal having the 25% duty cycle.

11. The method of claim 10, wherein the generating the control voltage comprises:
inverting, via an inverter, the combined digital signal to generate an inverse combined digital signal;
generate, via a first low pass filter, an average of the inverse combined digital signal;
generate, via a second low pass filter, an average of the combined digital signal;
receive, via a non-inverting input of an amplifier, the average of the inverse combined digital signal;
receive, via an inverting input of the amplifier, the average of the combined digital signal;
determining, via the amplifier, a difference in voltage between the average of the inverse combined digital signal and the average of the combined digital signal; and
amplifying, via the amplifier, the voltage difference to generate the control voltage.

12. The method of claim 10,
wherein the first buffer comprises a first transistor, a second transistor, and a third transistor,
wherein a gate of the first transistor is coupled to a first output of the differential VCO outputting the first sinusoidal signal, and a drain of the first transistor is coupled to a first input of the combining module,
wherein a gate of the second transistor is coupled to the first output of the differential VCO outputting the first sinusoidal signal, a drain of the second transistor is coupled to the first input of the combining module, and a source of the second transistor is coupled to a drain of the third transistor, and
wherein a gate of the third transistor is coupled to an output of the DCC module outputting the control voltage, and the drain of the third transistor is coupled to the source of the second transistor.

13. The method of claim 12,
wherein the second buffer comprises a fourth transistor, a fifth transistor, and a sixth transistor,
wherein a gate of the fourth transistor is coupled to a second output of the differential VCO outputting the second sinusoidal signal, and a drain of the fourth transistor is coupled to a second input of the combining module,
wherein a gate of the fifth transistor is coupled to the second output of the differential VCO outputting the second sinusoidal signal, a drain of the fifth transistor is coupled to the second input of the combining module, and a source of the fifth transistor is coupled to a drain of the sixth transistor, and
wherein a gate of the sixth transistor is coupled to the output of the DCC module outputting the control voltage, and the drain of the sixth transistor is coupled to the source of the fifth transistor.

14. The method of claim 13,
wherein a source of the first transistor and a source of the fourth transistor are coupled to a voltage source, and
wherein a source of the third transistor and a source of the sixth transistor are coupled to a ground node.

15. The method of claim 9, wherein the combining the first digital signal and the second digital signal to generate the combined digital signal comprises:
receiving the first digital signal from the first buffer as a first input;
receiving the second digital signal from the second buffer as a second input;
performing an exclusive-or operation using the first input and the second input; and
outputting a result of the exclusive-or operation as the combined digital signal.

16. The method of claim 9, wherein the doubling the second clock frequency of the combined digital signal to generate the output signal comprises:
receiving the combined digital signal from the combining module;
performing an exclusive-or operation using the combined digital signal as a first input and a delayed version of the combined digital signal as a second input; and
outputting a result of the exclusive-or operation as the output signal.

17. An apparatus for quadrupling a clock frequency, comprising:
means for outputting a first sinusoidal signal and a second sinusoidal signal according to a first clock frequency, wherein the first sinusoidal signal is out of phase with the second sinusoidal signal by half a cycle;
means for generating a first digital signal having a 25% duty cycle based on the first sinusoidal signal;
means for generating a second digital signal having a 25% duty cycle based on the second sinusoidal signal;
means for combining the first digital signal and the second digital signal to generate a combined digital signal having a 50% duty cycle, the combined digital signal having a second clock frequency that is double the first clock frequency; and
means for doubling the second clock frequency of the combined digital signal to generate an output signal having a third clock frequency that is quadruple the first clock frequency.

18. The apparatus of claim 17, further comprising:
means for generating, based on the combined digital signal, a control voltage for the means for generating the first digital signal and the means for generating the second digital signal,
wherein the control voltage controls a threshold of the means for generating the first digital signal facilitating generation of the first digital signal having the 25% duty cycle, and
wherein the control voltage controls a threshold of the means for generating the second digital signal facilitating generation of the second digital signal having the 25% duty cycle.

19. The apparatus of claim 18, wherein the means for generating the control voltage is configured to:
invert the combined digital signal to generate an inverse combined digital signal;
generate an average of the inverse combined digital signal;
generate an average of the combined digital signal;
receive, via a non-inverting input, the average of the inverse combined digital signal;
receive, via an inverting input, the average of the combined digital signal;
determine a difference in voltage between the average of the inverse combined digital signal and the average of the combined digital signal; and
amplify the voltage difference to generate the control voltage.

20. The apparatus of claim 18,
wherein the means for generating the first digital signal comprises a first transistor, a second transistor, and a third transistor,
wherein a gate of the first transistor is coupled to a first output of the means for outputting the first sinusoidal signal, and a drain of the first transistor is coupled to a first input of the means for combining,
wherein a gate of the second transistor is coupled to the first output of the means for outputting the first sinusoidal signal, a drain of the second transistor is coupled to the first input of the means for combining, and a source of the second transistor is coupled to a drain of the third transistor, and
wherein a gate of the third transistor is coupled to an output of the means for outputting the control voltage, and the drain of the third transistor is coupled to the source of the second transistor.

21. The apparatus of claim 20,
wherein the means for generating the second digital signal comprises a fourth transistor, a fifth transistor, and a sixth transistor,
wherein a gate of the fourth transistor is coupled to a second output of the means for outputting the second sinusoidal signal, and a drain of the fourth transistor is coupled to a second input of the means for combining,
wherein a gate of the fifth transistor is coupled to the second output of the means for outputting the second sinusoidal signal, a drain of the fifth transistor is coupled to the second input of the means for combining, and a source of the fifth transistor is coupled to a drain of the sixth transistor, and
wherein a gate of the sixth transistor is coupled to the output of the means for outputting the control voltage, and the drain of the sixth transistor is coupled to the source of the fifth transistor.

22. The apparatus of claim 21,
wherein a source of the first transistor and a source of the fourth transistor are coupled to a voltage source, and
wherein a source of the third transistor and a source of the sixth transistor are coupled to a ground node.

23. The apparatus of claim 17, wherein the means for combining the first digital signal and the second digital signal to generate the combined digital signal is configured to:
receive the first digital signal from the means for generating the first digital signal as a first input;
receive the second digital signal from the means for generating the second digital signal as a second input;
perform an exclusive-or operation using the first input and the second input; and
output a result of the exclusive-or operation as the combined digital signal.

24. The apparatus of claim 17, wherein the means for doubling the second clock frequency of the combined digital signal to generate the output signal is configured to:
receive the combined digital signal from the means for combining;
perform an exclusive-or operation using the combined digital signal as a first input and a delayed version of the combined digital signal as a second input; and
output a result of the exclusive-or operation as the output signal.
